(19) United States
(12) Patent Application Publication
(10) Pub. No.: US 2025/0231093 A1
(43) Pub. Date: Jul. 17, 2025

(54) RECONSTITUTED SUBSTRATE WARPAGE STIFFNESS MEASURING APPARATUS, RECONSTITUTED SUBSTRATE WARPAGE STIFFNESS MEASURING SYSTEM AND METHOD FOR MEASURING RECONSTITUTED SUBSTRATE WARAPGE STIFFNESS

(71) Applicant: Samsung Electronics Co., Ltd., Suwon-si (KR)

(72) Inventor: SANGLYONG SHIN, Suwon-si (KR)

(21) Appl. No.: 18/802,494

(22) Filed: Aug. 13, 2024

(30) Foreign Application Priority Data
Jan. 12, 2024 (KR) 10-2024-0005445

(51) Int. Cl. G01N 3/08

(52) U.S. Cl. CPC G01N 3/08; G01N 2203/0003; G01N 2203/0085; G01N 2203/0206

(57) ABSTRACT

A warpage stiffness measuring apparatus includes a stage supporting a reconstituted substrate, a measuring unit configured to generate warpage stiffness information of the reconstituted substrate, and a moving unit configured to move the measuring unit to predetermined positions on the reconstituted substrate. The measuring unit includes a measuring tip, a load cell configured to measure a force applied through the measuring tip to the reconstituted substrate in a vertical direction, and a push-pull gauge configured to measure a degree of deformation of the reconstituted substrate. At each of the predetermined positions, the measuring tip contacts the reconstituted substrate, the load cell measures a force applied to the reconstituted substrate by the measuring tip, and the push-pull gauge measures a degree of deformation of the reconstituted substrate. The warpage stiffness information includes the force and the degree of deformation measured at each of the plurality of predetermined positions.

### CROSS-REFERENCE TO RELATED APPLICATION

This application claims priority to and the benefit of Korean Patent Application No. 10-2024-0005445 filed in the Korean Intellectual Property Office on Jan. 12, 2024, the entire contents of which are herein incorporated by reference.

### BACKGROUND OF THE DISCLOSURE

### (a) Field of the Disclosure

The present disclosure relates to a reconstituted substrate stiffness measuring apparatus, a reconstituted substrate stiffness measuring system, and a reconstituted substrate stiffness measuring method.

### (b) Description of the Related Art

During a semiconductor manufacturing process in which a low temperature process and a high temperature process are performed alternately, heterogeneous materials on a reconstituted substrate repeat expansion and contraction. Because the heterogeneous materials formed on the reconstituted substrate have different thermal expansion coefficients, there are differences in the stress applied to each heterogeneous material during the repeated expansion and contraction. Due to the difference in the stress applied to each of these heterogeneous materials, the reconstituted substrate is bent into a U shape, and a warpage of the reconstituted substrate occurs.

The reconstituted substrate that is bent is handled by a vacuum adsorption by a vacuum unit for performing subsequent processes. At this time, one of factors to be considered in the vacuum adsorption is the warpage of the reconstituted substrate. The vacuum adsorption is performed by applying a force that is sufficient to secure the reconstituted substrate to the handling unit to the reconstituted substrate against the warpage of the reconstituted substrate.

Additionally, another factor to be considered in the vacuum adsorption is the stiffness of the reconstituted substrate. If the stiffness of the reconstituted substrate is strong, the force to restore the vacuum adsorbed reconstituted substrate o the warpage state becomes large, resulting in a vacuum leakage during the handling process and an adsorption error in the reconstituted substrate.

Conventionally, the reconstituted substrate was handled by measuring a warp value of the reconstituted substrate and applying the measured warp value to the process of the vacuum adsorption of the reconstituted substrate, but since the stiffness of the reconstituted substrate was not measured, stiffness information of the reconstituted substrate was not applied to the vacuum adsorption process while handling the reconstituted substrate.

Therefore, there is a need to develop apparatus and systems that may measure the stiffness of the reconstituted substrate.

### SUMMARY OF THE DISCLOSURE

A reconstituted substrate stiffness measuring apparatus, a reconstituted substrate stiffness measuring system, and a reconstituted substrate stiffness measuring method including a load cell sensor and a push-pull gauge are provided.

According to an aspect of the present disclosure, a reconstituted substrate warpage stiffness measuring apparatus includes a stage supporting a reconstituted substrate, a measuring unit disposed on an upper surface of the stage and configured to generate warpage stiffness information of the reconstituted substrate, and a moving unit disposed on the stage and moving the measuring unit to a plurality of predetermined positions on the reconstituted substrate. The measuring unit includes a measuring tip and a sensing unit having a load cell configured to measure a force applied through the measuring tip to the reconstituted substrate in a vertical direction and a push-pull gauge configured to measure a degree of deformation of the reconstituted substrate. At each of the plurality of predetermined positions, the measuring tip contacts the reconstituted substrate, the load cell measures a force applied to the reconstituted substrate by the measuring tip, and the push-pull gauge measures a degree of deformation of the reconstituted substrate. The warpage stiffness information includes the force and the degree of deformation measured at each of the plurality of predetermined positions.

According to a reconstituted substrate warpage stiffness measuring system includes a warpage stiffness measuring apparatus including a stage supporting a reconstituted substrate, a measuring unit disposed on an upper surface of the stage and configured to generate warpage stiffness information of the reconstituted substrate, and a moving unit disposed on the stage and moving the measuring unit to a plurality of predetermined positions on the reconstituted substrate, wherein the measuring unit includes a measuring tip and a sensing unit having a load cell configured to measure a force applied through the measuring tip to the reconstituted substrate in a vertical direction and a push-pull gauge configured to measure a degree of deformation of the reconstituted substrate, wherein at each of the plurality of predetermined positions, the measuring tip contacts the reconstituted substrate, the load cell measures a force applied to the reconstituted substrate by the measuring tip, and the push-pull gauge measures a degree of deformation of the reconstituted substrate, and wherein the force and the degree of deformation measured at each of the plurality of predetermined positions constitute the warpage stiffness information, an input unit for inputting the plurality of predetermined positions and a general information about the reconstituted substrate, an analysis unit configured to derive a plurality of warpage stiffness values of the plurality of predetermined positions from the general information of the reconstituted substrate and the warpage stiffness information, and a storage unit that stores the plurality of warpage stiffness values.

According to an aspect of the present disclosure, a method of measuring a reconstituted substrate warpage stiffness includes mounting a reconstituted substrate on a stage, moving a measuring unit to an origin of a Cartesian coordinate defining a moving path of the measuring unit, wherein the measuring unit includes a sensing unit and a measuring tip, and the sensing unit includes a load cell sensor and a push-pull gauge, moving the measuring unit by a moving unit so that the measuring tip contacts the reconstituted substrate at a first predetermined position of a plurality of predetermined positions within the Cartesian coordinate, and measuring a warpage stiffness information at the first predetermined position on the reconstituted substrate by the load cell sensor and the push-pull gauge through the measuring tip.

By measuring the stiffness of the reconstituted substrate for each product, it is possible to secure the equipment operability of the product and increase the yield of the product.

By securing the stiffness information of the reconstituted substrate, it is possible to predict the equipment operability of the product from the time of a product development and increase a product productivity.

By applying the stiffness information of the reconstituted substrate to the vacuum adsorption input value of the reconstituted substrate, a vacuum leakage may be prevented during the handling process of the reconstituted substrate.

### BRIEF DESCRIPTION OF THE DRAWINGS

FIG. 1 is a perspective view showing a reconstituted substrate stiffness measuring apparatus according to an embodiment.

FIG. 2 is a top plan view showing a reconstituted substrate stiffness measuring apparatus according to an embodiment.

FIG. 3 is a view showing a cross-section shape of a measuring tip of a reconstituted substrate stiffness measuring apparatus according to an embodiment.

FIG. 4 is a view showing a reconstituted substrate stiffness measuring system, including a side view of a reconstituted substrate stiffness measuring apparatus of an embodiment.

FIG. 5 to FIG. 9 are top plan views to explain a method for measuring a stiffness of a reconstituted substrate according to an embodiment.

FIG. 10 is a top plan view showing disposing a panel on a reconstituted substrate stiffness measuring apparatus.

### DETAILED DESCRIPTION OF THE EMBODIMENTS

Exemplary embodiments of the present invention will hereinafter be described in detail with reference to the accompanying drawings in order that those skilled in the art can easily practice the invention. As those skilled in the art would realize, the described embodiments may be modified in various different ways, all without departing from the spirit or scope of the present invention.

To clarify the present invention, descriptions of irrelevant portions are limited, and like numbers refer to like elements throughout the specification.

Further, in the drawings, a size and thickness of each element are randomly represented for better understanding and ease of description, and the present invention is not limited thereto.

Throughout this specification and the claims that follow, when it is described that an element is “coupled” to another element, the element may be “directly coupled” to the other element or “indirectly coupled” to the other element through a third element. In addition, unless explicitly described to the contrary, the word “comprise”, and variations such as “comprises” or “comprising”, will be understood to imply the inclusion of stated elements but not the exclusion of any other elements.

In addition, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, in the specification, the word “on” or “above” means positioned on or below the object portion, and does not necessarily mean positioned on the upper side of the object portion based on a gravitational direction.

Further, in the specification, the phrase “in a plan view” means when an object portion is viewed from above, and the phrase “in a cross-section” means when a cross-section taken by vertically cutting an object portion is viewed from the side.

Hereinafter, a reconstituted substrate stiffness measuring apparatus 100, a reconstituted substrate stiffness measuring system 200, and a reconstituted substrate stiffness measuring method according to an embodiment are described with reference to accompanying drawings.

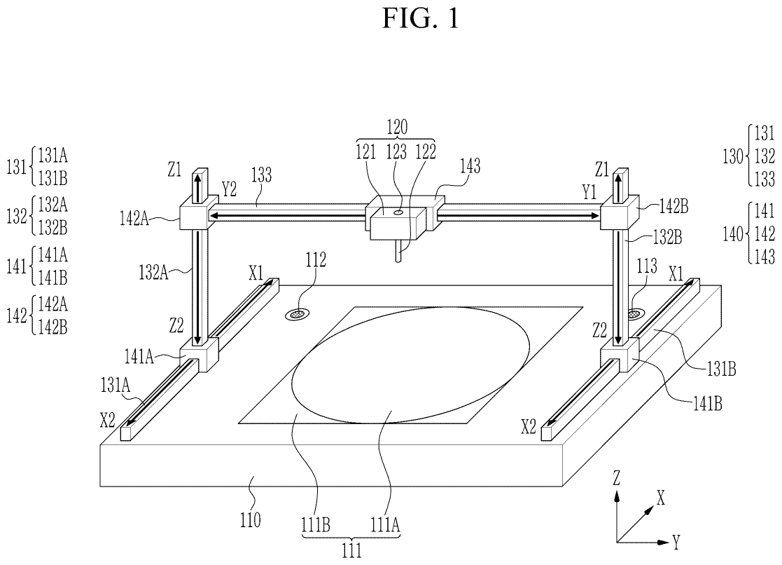

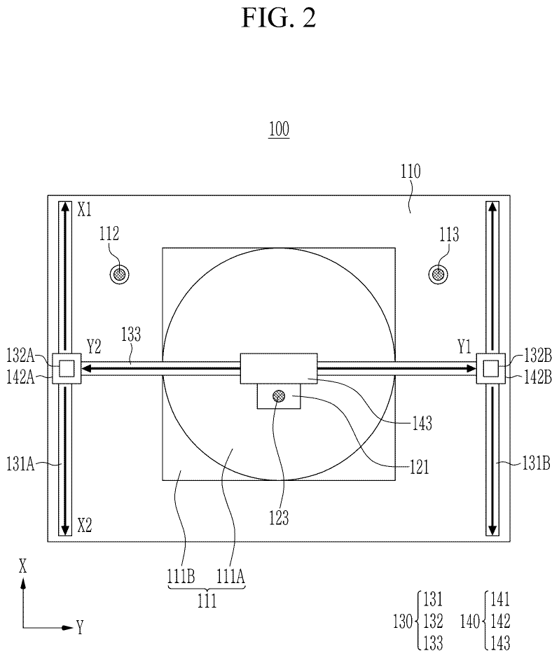

FIG. 1 is a perspective view showing a reconstituted substrate stiffness measuring apparatus 100 according to an embodiment. FIG. 2 is a top plan view showing a reconstituted substrate stiffness measuring apparatus 100 according to an embodiment.

Referring to FIG. 1 and FIG. 2, a reconstituted substrate stiffness measuring apparatus 100 includes a stage 110, a measuring unit 120, a guide rail 130, and a moving unit 140.

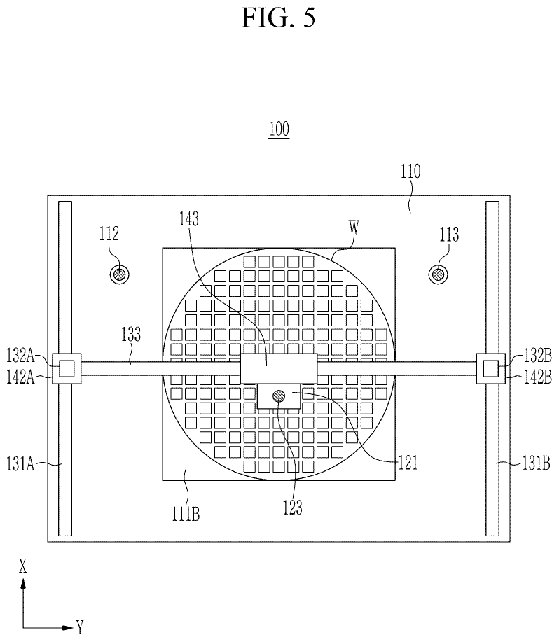

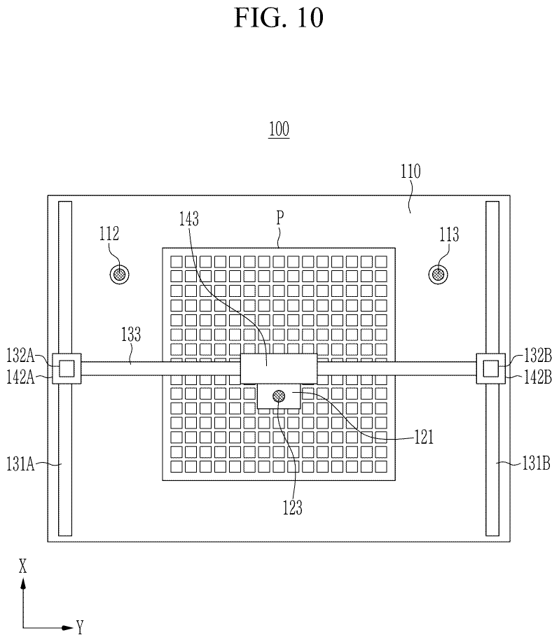

The stage 110 includes a reconstituted substrate mounting unit 111, an origin displaying unit 112, and a cleaning unit 113. The stage 110 is a frame with a larger area than a substrate. For example, where the substrate is a semiconductor wafer W of FIG. 5, the frame of the stage 110 may have a larger area than an area of the semiconductor wafer W. In an embodiment, the wafer W may be a reconstituted wafer. In a case where the substrate is a panel P of FIG. 10, the frame of the stage 110 may have a larger area than an area of the panel P. In an embodiment, the panel P may be a reconstituted panel. Hereinafter, the substrate may be a reconstituted substrate. The substrate and the reconstituted substrate are interchangeably referred to, the wafer W and the reconstituted wafer W are interchangeably referred to, and the panel P and the reconstituted panel P are interchangeably referred to. The reconstituted substrate transferred into the reconstituted substrate stiffness measuring apparatus 100 is positioned on the reconstituted substrate mounting unit 111. A warpage stiffness of the reconstituted substrate is measured on the reconstituted substrate mounting unit 111. Warpage may occur due to non-uniform thermal expansion or residual stresses within the reconstituted substrate. The stage 110 supports the reconstituted substrate. In an embodiment, the reconstituted substrate may include a semiconductor wafer to which a fan out wafer level package (FOWLP) technology is applied or a reconstituted panel P includes a panel to which a fan out panel level package (FOPLP) technology is applied. The reconstituted substrate mounting unit 111 includes a semiconductor wafer mounting unit 111A and a panel mounting unit 111B. The semiconductor wafer W is mounted on the semiconductor wafer mounting unit 111A to measure warpage stiffness. The panel P is mounted on the panel mounting unit 111B to measure warpage stiffness. The measuring unit 120, the guide rail 130, and the moving unit 140 are disposed on the stage 110.

The origin displaying unit 112 is a part displayed to confirm an origin of a Cartesian coordinate defining a moving path of the measuring unit 120. The origin display unit 112 is located at the origin of the Cartesian coordinate. Before measuring the stiffness of the reconstituted substrate, and after measuring the stiffness of the reconstituted substrate, the measuring unit 120 moves to the origin displaying unit 112. The measuring tip 122 of the moved measuring unit 120 is in contact with the origin displaying unit 112 to confirm the origin. The origin confirmed in this way becomes a reference for the position of the measuring unit 120, and the measuring unit 120 moves by the moving unit 140 based on the origin to measure the stiffness of the reconstituted substrate. In addition, at the origin displaying unit 112, a height of the measuring tip 122 relative to an upper surface of the reconstituted substrate mounting unit 111 or an upper surface of the stage 110 may be set to a reference height at the origin of the Cartesian coordinate. In an embodiment, the setting to the reference height of the measuring tip 122 (i.e., a lower end of the measuring tip 122) may include 1) moving the measuring tip 122 toward the origin displaying unit 112; and 2) stopping the moving of the measuring tip 122 when contact of the lower end of the measuring tip 122 is detected. In an embodiment, the origin displaying unit 112 may include a contact sensor such as a pressure-sensitive pad and a tactile sensor.

The cleaning unit 113 is a part that cleans the measuring tip 122 of the measuring unit 120. From inside of the reconstituted substrate stiffness measuring apparatus 100 or from the reconstituted substrate during measuring the stiffness of the reconstituted substrate, a contamination material may stick to the measuring tip 122 of the measuring unit 120. The cleaning unit 113 removes the contamination material smeared to the measuring tip 122 of the measuring unit 120, thereby improving the measuring accuracy of the stiffness of the reconstituted substrate. Before measuring the stiffness of the reconstituted substrate, and after measuring the stiffness of the reconstituted substrate, the measuring unit 120 moves to the cleaning unit 113. The cleaning unit 113 may include a container in which a cleaning solution is accommodated. The measuring tip 122 of the moved measuring unit 120 is immersed in the cleaning solution of the cleaning unit 113. The cleaning solution may facilitate to chemically remove the contaminant material smeared on the measuring tip 122 of the measuring unit 120. In an embodiment, the cleaning unit 113 may further include an ultrasonic vibrator attached to the container to agitate the cleaning solution, thereby aiding in the physical removal of contaminants.

The measuring unit 120 includes a sensing unit 121, a measuring tip 122, and a measuring tip displaying unit 123. The sensing unit 121 extends from one side of a third moving unit 143. In an embodiment, the sensing unit 121 may include a load cell sensor and a push-pull gauge. The load cell sensor and the push-pull gauge measure warpage stiffness information at an arbitrary position of the reconstituted substrate through measuring tip 122.

The reconstituted substrate is handled by being vacuum-adsorbed by a vacuum unit for performing subsequent processes. At this time, the characteristics of the reconstituted substrate that must be considered for the vacuum adsorption are a warpage of the reconstituted substrate and a stiffness thereof. The warpage of the reconstituted substrate is a difference between a minimum and maximum distances between the reconstituted substrate and a reference plane. The greater the warpage of the reconstituted substrate, the greater the difference between the minimum and maximum distances between the reconstituted substrate and the reference plane. The vacuum adsorption is performed by applying a force that is sufficient to secure the reconstituted substrate to the handling unit to the reconstituted substrate against the warpage of the reconstituted substrate. For example, the vacuum adsorption is performed by applying a vacuum force sufficient to secure the reconstituted substrate to the handling unit, effectively counteracting any warpage of the reconstituted substrate.

The warpage stiffness refers to the resistance of the reconstituted substrate to warping, which is a type of deformation where different parts of the material in the reconstituted substrate bend or twist in different directions. If the warpage stiffness of the reconstituted substrate is strong, the force to restore the vacuum adsorbed reconstituted substrate to the bent state during the handling process is large, thereby resulting in a vacuum leakage and an adsorption error in the reconstituted substrate.

The load cell sensor measures the force (load) applied to the reconstituted substrate. In an embodiment, the load cell sensor measures the force applied from the measuring tip 122 to the reconstituted substrate in a direction perpendicular to the upper surface of the reconstituted substrate mounting unit 111. The force may be referred to as a downward force. The push-pull gauge measures the degree of the deformation of the reconstituted substrate. In an embodiment, the push-pull gage measures a height change of the measuring tip 122 (i.e., the lower end of the measuring tip 122) which is caused by the downward force applied from the measuring tip 122 to the reconstituted substrate. According to the present disclosure, the warpage stiffness information of the reconstituted substrate may be measured using the load cell sensor and the push-pull gauge. The warpage stiffness information of the reconstituted substrate may be applied to a vacuum adsorption input value of the reconstituted substrate, and a vacuum force of a vacuum unit is adjusted according to the warpage stiffness information, and then the vacuum leakage during the handling process of the reconstituted substrate may be prevented. In an embodiment, the warpage stiffness information may include the downward force applied by the measuring tip 122 and the height change of the measuring tip 122 as a degree of deformation of the reconstituted substrate.

The measuring tip 122 extends downward in a vertical direction from the sensing unit 121. In an embodiment, the vertical direction may be a direction perpendicular to the upper surface of the reconstituted substrate mounting unit 111 or the upper surface of the stage 110. The measuring tip 122 is in contact with the predetermined position of the reconstituted substrate and transfers the information to the sensing unit 121. In an embodiment, the cross-section shape of the measuring tip 122 in a horizontal plane may have various shapes. The horizontal plane may be parallel to the upper surface of the reconstituted substrate mounting unit 111 or the upper surface of the stage.

The measuring tip displaying unit 123 is positioned on the upper surface of the sensing unit 121. The measuring tip displaying unit 123 serves to display where the measuring tip 122 is on the reconstituted substrate. In an embodiment, the measuring tip display unit 123 may include a transparent material such as glass or plastic.

The guide rail 130 is disposed on the stage 110. The guide rail 130 may define and guide a moving path of the moving unit 140. The guide rail 130 includes a first guide rail 131, a second guide rail 132, and a third guide rail 133. The moving unit 140 is disposed on the guide rail 130. The moving unit 140 moves along the moving path defined by the guide rail 130. The moving unit 140 includes a first moving unit 141, a second moving unit 142, and a third moving unit 143. At least one of the guide rail 130 and the moving unit 140, is linked with a motor to move the moving unit 140.

The first guide rail 131 includes a pair of a left first guide rail 131A disposed at the first edge on the stage 110 and a right first guide rail 131B disposed at the second edge opposite the first edge on the stage 110. Each of the pair of first guide rails 131A and 131B extends in a first horizontal direction (an X direction). The pair of first guide rails 131A and 131B extend parallel to each other. The pair of first guide rails 131A and 131B are spaced apart from each other in a second horizontal direction (a Y direction). The pair of first guide rails 131A and 131B are fixedly attached to the stage 110.

The first moving unit 141 includes a pair of first moving units including a left first moving unit 141A disposed on the left first guide rail 131A which is fixedly attached to the first edge and a right first moving unit 141B disposed on the right first guide rail 131B which is fixedly attached to the second edge. The left first moving unit 141A moves along the left first guide rail 131A in the first horizontal direction (the X direction) or in an opposite direction thereof. In FIG. 1, an arrow X1 and an arrow X2 represent the movement path of the first moving unit 141 on the first guide rail 131. The arrow X1 may correspond to the first horizontal direction, and the arrow X2 may correspond to a direction opposite to the first horizontal direction. The right first moving unit 141B moves along the right first guide rail 131B in the first horizontal direction, indicated by the arrow X1 or in the opposite direction thereof, indicated by the arrow X2. The left first moving unit 141A and the right first moving unit 141B are disposed to be spaced apart in the second horizontal direction (a Y direction) that intersects the first horizontal direction (the X direction). The left first moving unit 141A and the right first moving unit 141B move side by side and together along the first horizontal direction (the X direction).

The second guide rail 132 includes a left second guide rail 132A disposed on the left first moving unit 141A and a right second guide rail 132B disposed on the right first moving unit 141B. The left second guide rail 132A extends from the first moving unit 141A in the vertical direction (a Z direction). The left second guide rail 132A moves in the first horizontal direction (the X1 direction or the X2 direction) together with the left first moving unit 141A. The right second guide rail 132B extends from the right first moving unit 141B in the vertical direction (the Z direction). The right second guide rail 132B moves in the first horizontal direction (the X1 direction or the X2 direction) together with the right first moving unit 141B. The left second guide rail 132A and the right second guide rail 132B are disposed to be spaced apart in the second horizontal direction (the Y direction). The left second guide rail 132A and the right second guide rail 132B extend parallel to each other. The left second guide rail 132A and the right second guide rail 132B move side by side and together along the first horizontal direction (the X direction).

The second moving unit 142 includes a left second moving unit 142A disposed on the left second guide rail 132A and a right second moving unit 142B disposed on the right second guide rail 132B. The left second moving unit 142A moves in the vertical direction along the left second guide rail 132A in the vertical direction (a Z1 direction or a Z2 direction opposite to the Z1 direction). The left second moving unit 142A moves in the first horizontal direction (the X direction) together with the left first moving unit 141A. In FIG. 1, the arrow Z1 and the arrow Z2 represent the movement path of the second moving unit 142 on the second guide rail 132. The right second moving unit 142B moves along the corresponding second guide rail 132B in the vertical direction (the Z1 direction or the Z2 direction). The right second moving unit 142B moves in the first horizontal direction (the X direction) together with the right first moving unit 141B. The left second moving unit 142A and the right second moving unit 142B are disposed to be spaced apart in the second horizontal direction (the Y direction). The left second moving unit 142A and the right second moving unit 142B move side by side and together along the vertical direction (the Z direction) and along the first the horizontal direction (the X direction).

The third guide rail 133 extends in the second horizontal direction (the Y direction) between the left second moving unit 142A and the right second moving unit 142B. The third guide rail 133 moves in the vertical direction (the Z1 direction or the Z2 direction) together with the left second moving unit 142A and the right second moving unit 142B. The third guide rail 133 moves in the first horizontal direction (the X direction) together with the left first moving unit 141A and the right first moving unit 141B.

The third moving unit 143 is disposed on the third guide rail 133. The third moving unit 143 moves along the third guide rail 133 in the second horizontal direction (the Y1 direction or the Y2 direction). In FIG. 1, the arrow Y1 and the arrow Y2 indicate the movement path of the third moving unit 143 on the third guide rail 133. The third moving unit 143 moves in the vertical direction (the Z direction) together with the left second moving unit 142A and the right second moving unit 142B. The third moving unit 143 moves in the first horizontal direction (the X1 direction and the X2 direction) together with the left first moving unit 141A and the right first moving unit 141B.

The measuring unit 120 is attached to the third moving unit 143. The measuring unit 120 moves together with the third moving unit 143. The measuring unit 120 moves in the first horizontal direction (the X direction) by the pair of first moving units 141A and 141B. The measuring unit 120 moves in the vertical direction (the Z direction) by the pair of second moving units 142A and 143B. The measuring unit 120 moves in the second horizontal direction (the Y direction) by the third moving unit.

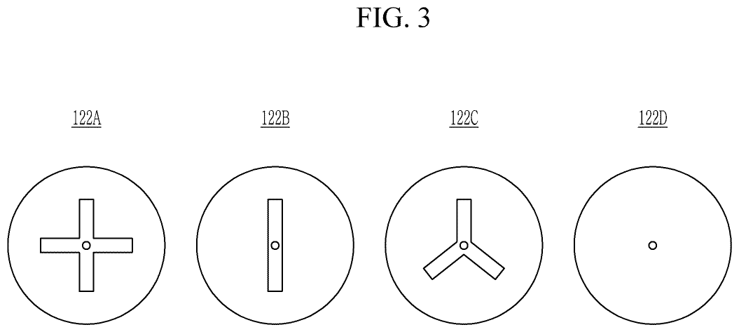

FIG. 3 is a view showing a cross-section shape of a measuring tip 122 of a reconstituted substrate stiffness measuring apparatus 100 of an embodiment.

Referring to FIG. 3, by varying the cross-section shape of the measuring tip 122 in the horizontal direction according to the measuring position in the reconstituted substrate, the stiffness of the reconstituted substrate may be measured more accurately. In an embodiment, the cross-section shape of the measuring tip 122 in the horizontal plane may include a cross 122A, a straight line 122B, a Y-shape 122C, or a circle shape 122D.

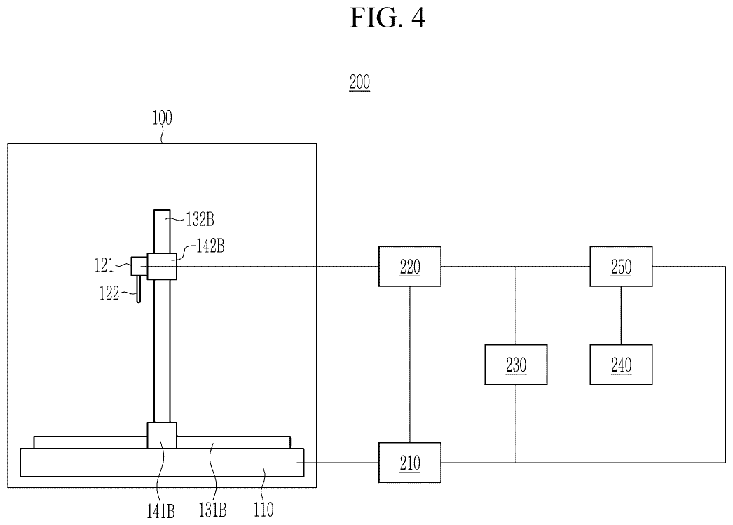

FIG. 4 is a view showing a reconstituted substrate stiffness measuring system 200 including a reconstituted substrate stiffness measuring apparatus 100 of an embodiment. In FIG. 4, a side view of the reconstituted substrate stiffness measuring apparatus 100 is shown.

Referring to FIG. 4, the reconstituted substrate stiffness measuring system 200 includes a reconstituted substrate stiffness measuring apparatus 100, an input unit 210, an analysis unit 220, a storage unit 230, a displaying unit 240, and a control unit 250.

The input unit 210 is connected to the reconstituted substrate stiffness measuring apparatus 100. A predetermined measuring position of the reconstituted substrate and a general information of the reconstituted substrate are input to the input unit 210. In an embodiment, the predetermined measuring position of the reconstituted substrate may include a position determined based on a warpage value of the reconstituted substrate and a fixed measuring position. In an embodiment, the general information of the reconstituted substrate may include whether the reconstituted substrate is a semiconductor wafer W or a panel P, a warpage value of the reconstituted substrate, and a thickness of the reconstituted substrate. In an embodiment, the input unit 210 may include a keyboard or a touch pad.

The analysis unit 220 is connected to the sensing unit 121, the input unit 210, and the storage unit 230. The analysis unit 220 aggregates and analyzes the stiffness information such as the force (the load) applied to the reconstituted substrate measured by the load cell sensor in the sensing unit 121 and the degree of the deformation of the reconstituted substrate measured by the push-pull gauge of the sensing unit 121 and the general information such as the warpage value of the reconstituted substrate input to the input unit 210 or stored in the storage unit 230, and the thickness of the reconstituted substrate W, and derives the warpage stiffness value of the reconstituted substrate W. In some embodiments, the degree of the deformation of the reconstituted substrate may be represented by a change in a height of the lower end of the measuring tip 122. For example, the degree of the deformation may be obtained by measuring a height change of the lower end of the measuring tip 122 which contacts the reconstituted substrate W.

The storage unit 230 is connected to the analysis unit 220 and the input unit 210. The storage unit 230 stores the general information such as the warpage value of the reconstituted substrate input to the input unit 210 and the thickness of the reconstituted substrate, and the warpage stiffness value of the reconstituted substrate analyzed in the analysis unit 220. The storage unit 230 may include a volatile semiconductor memory device such as a dynamic random access memory (DRAM) or a non-volatile semiconductor memory device such as a NAND flash memory.

The displaying unit 240 is connected to the storage unit 230. The displaying unit 240 displays the general information such as the warpage value of the reconstituted substrate stored in the storage unit 230 and the thickness of the reconstituted substrate, and the warpage stiffness value of the reconstituted substrate.

The control unit 250 is connected to the measuring unit 120, the guide rail 130, and the moving unit 140 of the reconstituted substrate stiffness measuring apparatus 100, and the input unit 210, the analysis unit 220, the storage unit 230, and the displaying unit 240 of the reconstituted substrate stiffness measuring system 200. The control unit 250 determines whether the reconstituted substrate is the semiconductor wafer W or the panel P, controls a measuring operation of the measuring unit 120 and a moving path of the moving unit 140, and controls the input unit 210, the analysis unit 220, the storage unit 230, and the displaying unit 240.

FIG. 5 to FIG. 9 are top plan views to explain a method for measuring a stiffness of a reconstituted substrate of an embodiment.

FIG. 5 is a top plan view showing disposing a semiconductor wafer W on a reconstituted substrate stiffness measuring apparatus 100.

Referring to FIG. 2 and FIG. 5, the semiconductor wafer W is mounted on a reconstituted substrate mounting unit 111. In an embodiment, the semiconductor wafer W may be a reconstituted wafer.

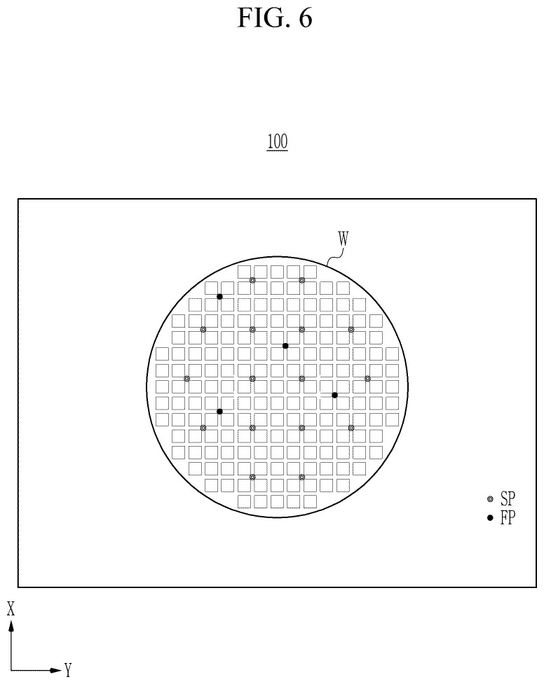

FIG. 6 is a top plan view showing determining the measuring position on the semiconductor wafer W.

Referring to FIG. 6, the measuring position on the semiconductor wafer W is determined. The predetermined position on the semiconductor wafer W is input to an input unit 210. In an embodiment, the predetermined position may include a position FP determined based on the warpage value of the semiconductor wafer W measured in advance and a fixed measuring position SP. Considering conditions such as the warpage value of the semiconductor wafer W, a general condition of the semiconductor wafer W, and an importance of a product, a larger or smaller number of positions FP determined based on the warpage value of the semiconductor wafer W measured in advance and the fixed measuring positions SP may be determined. For example, depending on the warpage, general condition, and product importance of the semiconductor wafer W, the number of positions FP, determined based on the measured warpage value and the fixed measuring positions SP, may vary. The general information of the semiconductor wafer W measured in advance is input into the input unit 210. In an embodiment, the general information of the semiconductor wafer W may include whether the reconstituted substrate is the semiconductor wafer W or the panel P, the warpage value of the semiconductor wafer W, and the thickness of the semiconductor wafer W.

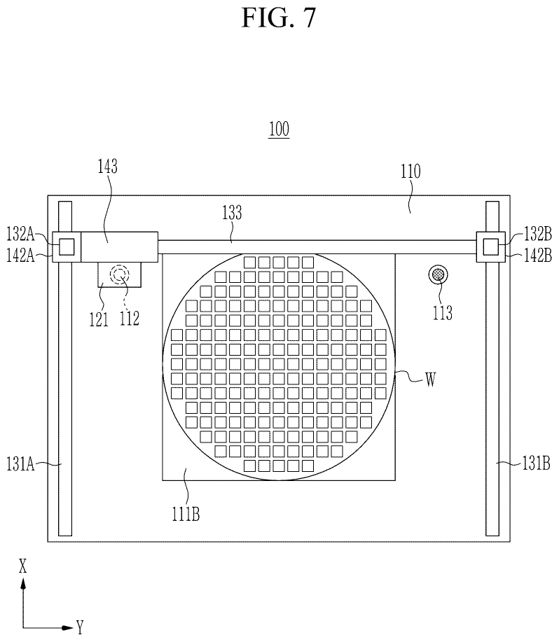

FIG. 7 is a top plan view showing moving a measuring unit 120 to a reference point of the reconstituted substrate stiffness measuring apparatus 100. The reference point corresponds to the origin of the Cartesian coordinate defining the moving path of the measuring unit 120.

Referring to FIG. 7, a measuring unit 120 is moved to the reference point. At the reference point, a lower end of the measuring tip 122 is set to the reference height. Afterwards, the measuring tip 122 of the measuring unit 120 contacts an origin displaying unit 112 which is located at the reference point. As a result, the error in the stiffness measurement of the semiconductor wafer W may be reduced by determining a reference height at the origin of the Cartesian coordinate defining the moving path of the measuring unit 120 before measuring the warpage stiffness information at the position FP determined based on the warpage value of the semiconductor wafer W measured in advance and the fixed measuring position SP. In FIG. 7, since the origin displaying unit 112 is obscured by the sensing unit 121 on the plan view, the origin displaying unit 112 is shown as a dotted line.

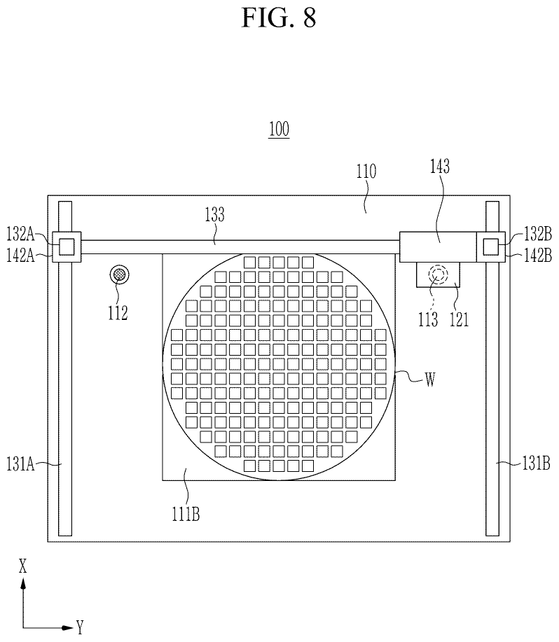

FIG. 8 is a top plan view showing moving a measuring unit 120 to a cleaning unit 113.

Referring to FIG. 8, before measuring the stiffness of the semiconductor wafer W, the measuring unit 120 moves to the cleaning unit 113. Afterwards, the measuring tip 122 of the moved measuring unit 120 is immersed in the cleaning solution included in the cleaning unit 113. As a result, it is possible to remove the contaminated material adhered to the measuring tip 122 of the measuring unit 120, thereby improving the accuracy of the stiffness measurement of the semiconductor wafer W.

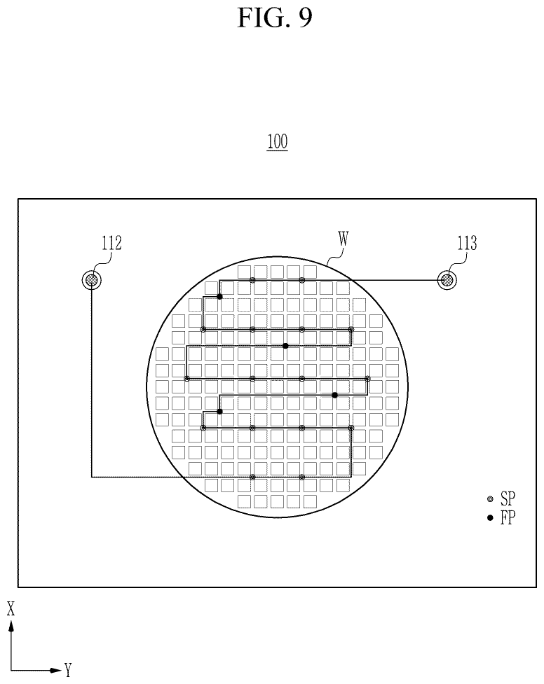

FIG. 9 is a top plan view showing a moving path that a measuring unit 120 moves on a semiconductor wafer W while measuring a stiffness of a semiconductor wafer W.

Referring to FIG. 9, the moving unit 140 moves along the guide rail 130 and moves the measuring unit 120 in the first horizontal direction (the X direction) and the second horizontal direction (the Y direction) toward a predetermined position. When the measuring unit 120 arrives at a first predetermined position on wafer W, the measuring unit 120 moves in the vertical direction (the Z direction; referring to FIG. 1) so that the measuring tip 122 contacts the predetermined position on the semiconductor wafer W. The warpage stiffness information is measured at the predetermined position on the semiconductor wafer W by using the load cell sensor and the push-pull gauge through the measuring tip 122. Afterwards, the measuring unit 120 moves to the next predetermined position (e.g., a second predetermined position), and the warpage stiffness information is measured at the second predetermined position on the semiconductor wafer W, and these processes are repeated until all of the predetermined positions are measured. When the measuring is completed, the measuring unit 120 moves to the origin displaying unit 112.

Next, in the analysis unit 220, the warpage stiffness information such as the force (the load) applied to the semiconductor wafer W measured by the load cell sensor in sensing unit 121 and the degree of the deformation of the semiconductor wafer W measured by the push-pull gauge of the sensing unit 121, and the general information such as the warpage value of the input unit 210 and the storage unit 230, and the thickness of the semiconductor wafer W are analyzed to derive the warpage stiffness value of the semiconductor wafer W.

Afterwards, the derived warpage stiffness value of the semiconductor wafer W is stored in the storage unit 230, displayed on the display unit 240, and transmitted and reported to the upper system.

FIG. 10 is a top plan view showing disposing a panel P on a reconstituted substrate stiffness measuring apparatus 100.

Referring to FIG. 10, the panel P is mounted on the reconstituted substrate mounting unit 111. In an embodiment, the panel P may be a reconstituted panel.

Afterwards, the stiffness measuring of the panel P is applied with the contents of FIG. 6 to FIG. 9 in which the stiffness measuring of the semiconductor wafer W is described.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A reconstituted substrate warpage stiffness measuring apparatus comprising:
a stage supporting a reconstituted substrate;
a measuring unit disposed on an upper surface of the stage and configured to generate warpage stiffness information of the reconstituted substrate; and
a moving unit disposed on the stage and moving the measuring unit to a plurality of predetermined positions on the reconstituted substrate,
wherein the measuring unit includes a measuring tip and a sensing unit having a load cell configured to measure a force applied through the measuring tip to the reconstituted substrate in a vertical direction and a push-pull gauge configured to measure a degree of deformation of the reconstituted substrate,
wherein at each of the plurality of predetermined positions, the measuring tip contacts the reconstituted substrate, the load cell measures a force applied to the reconstituted substrate by the measuring tip, and the push-pull gauge measures a degree of deformation of the reconstituted substrate, and
wherein the warpage stiffness information includes the force and the degree of deformation measured at each of the plurality of predetermined positions.

2. The apparatus of claim 1,
wherein the stage includes a cleaning unit for cleaning the measuring tip.

3. The apparatus of claim 1,
wherein a cross-section shape of the measuring tip in a horizontal plane parallel to the upper surface of the stage is a cross, straight line, Y-shape, or circle shape.

4. The apparatus of claim 1,
wherein the stage includes an origin displaying unit, which is located at an origin of Cartesian coordinate in which a moving path of the measuring unit is defined.

5. The apparatus of claim 1,
wherein the moving unit includes:
a pair of first moving units that move the measuring unit in a first horizontal direction parallel to the upper surface of the stage;
a pair of second moving units that move the measuring unit in the vertical direction; and
a third moving unit moves the measuring unit in a second horizontal direction parallel to the upper surface of the stage and intersecting the first horizontal direction.

6. The apparatus of claim 5, further comprising:
a pair of first guide rails disposed on the stage,
wherein each of the pair of first guide rails extends in the first horizontal direction,
wherein the pair of first guide rails are spaced apart from each other in the second horizontal direction, and
wherein the pair of first moving units move along the pair of first guide rails, respectively.

7. The apparatus of claim 5, further comprising:
a pair of second guide rails extending in the vertical direction,
wherein the pair of second guide rails are spaced apart from each other in the second horizontal direction,
wherein the pair of second guide rails are disposed on the pair of the first moving units, respectively, and
wherein the pair of second moving units move along the pair of second guide rails, respectively.

8. The apparatus of claim 5, further comprising:
a third guide rail extending in the second horizontal direction between the pair of second moving units,
wherein the third moving unit moves along the third guide rail.

9. The apparatus of claim 1,
wherein the reconstituted substrate includes a reconstituted wafer or a reconstituted panel.

10. A reconstituted substrate warpage stiffness measuring system comprising:
a warpage stiffness measuring apparatus, wherein the stiffness measuring apparatus includes a stage supporting a reconstituted substrate; a measuring unit disposed on an upper surface of the stage and configured to generate warpage stiffness information of the reconstituted substrate; and a moving unit disposed on the stage and moving the measuring unit to a plurality of predetermined positions on the reconstituted substrate, wherein the measuring unit includes a measuring tip and a sensing unit having a load cell configured to measure a force applied through the measuring tip to the reconstituted substrate in a vertical direction and a push-pull gauge configured to measure a degree of deformation of the reconstituted substrate, wherein at each of the plurality of predetermined positions, the measuring tip contacts the reconstituted substrate, the load cell measures a force applied to the reconstituted substrate by the measuring tip, and the push-pull gauge measures a degree of deformation of the reconstituted substrate, and wherein the warpage stiffness information includes the force and the degree of deformation measured at each of the plurality of predetermined positions;
an input unit for inputting the plurality of predetermined positions and a general information about the reconstituted substrate;
an analysis unit configured to derive a plurality of warpage stiffness values of the plurality of predetermined positions from the general information of the reconstituted substrate and the warpage stiffness information; and
a storage unit that stores the plurality of warpage stiffness values.

11. The system of claim 10, further comprising:
a display unit that displays the plurality of warpage stiffness values at the plurality of predetermined positions.

12. The system of claim 11, further comprising:
a control unit that controls the measuring unit, the moving unit, the input unit, the analysis unit, the storage unit, and the display unit.

13. The system of claim 10,
wherein the general information of the reconstituted substrate includes a warpage value of the reconstituted substrate.

14. The system of claim 13,
wherein the plurality of predetermined positions include:
a position determined based on the warpage value of the reconstituted substrate; and
a fixed measuring position.

15. The system of claim 10,
wherein the general information of the reconstituted substrate includes a thickness of the reconstituted substrate.

16. A method of measuring a reconstituted substrate warpage stiffness comprising:
mounting a reconstituted substrate on a stage;
moving a measuring unit to an origin of a Cartesian coordinate defining a moving path of the measuring unit, wherein the measuring unit includes a sensing unit and a measuring tip, and the sensing unit includes a load cell sensor and a push-pull gauge;
moving the measuring unit by a moving unit so that the measuring tip contacts the reconstituted substrate at a first predetermined position of a plurality of predetermined positions within the Cartesian coordinate; and
measuring a warpage stiffness information at the first predetermined position on the reconstituted substrate by the load cell sensor and the push-pull gauge through the measuring tip.

17. The method of claim 16, further comprising:
inputting general information and the plurality of predetermined positions of the reconstituted substrate before moving the measuring unit to the origin,
wherein the general information includes a warpage value of the reconstituted substrate, a thickness of the reconstituted substrate, and a stiffness value of the reconstituted substrate.

18. The method of claim 16, further comprising:
cleaning the measuring tip before moving the measuring unit by the moving unit.

19. The method of claim 16, further comprising:
deriving a warpage stiffness value of the first predetermined position after measuring warpage stiffness information of the first predetermined position.

20. The method of claim 19, further comprising:
storing, transmitting, and displaying the warpage stiffness value after deriving the stiffness value.
